(19) United States
(12) Patent Application Publication
(10) Pub. No.: US 2012/0155885 A1
(43) Pub. Date: Jun. 21, 2012

(54) RACK TO RACK OPTICAL COMMUNICATION

(76) Inventors: Eric C. Hannah, Pebble Beach, CA (US); John L. Gustafson, Pleasanton, CA (US); Shivani A. Sud, Santa Clara, CA (US); Nicholas P. Carter, Santa Clara, CA (US); Joshua B. Fryman, Corvallis, OR (US); Roy Want, Los Altos, CA (US)

(21) Appl. No.: 12/974,524

(22) Filed: Dec. 21, 2010

(51) Int. Cl. H04B 10/10

(52) U.S. Cl. 398/128

(57) ABSTRACT

In some embodiments a light transceiver is associated with a computing rack and is adapted to transmit and/or receive one or more light beams via air to and/or from a second light transceiver associated with a second computing rack to communicate information between the computing rack and the second computing rack. Other embodiments are described and claimed.

### TECHNICAL FIELD

The inventions generally relate to rack to rack optical communications (for example, rack to rack free space optics).

### BACKGROUND

As exascale computing and enterprise clusters become more and more important, data transmission and Input/Output (I/O) between racks of computers will become more and more of a limitation on performance and power scaling. Additionally, data centers will need to manage more and more dynamically changing multi-tenancy as time goes on. Enabling a dynamically reconfigurable data center without requiring manual intervention will provide important cost savings, and goes a long way toward automating the data center configuration.

Optical fiber is currently used to couple between server racks in most data centers. However, fiber optical cables are labor intensive and bulky, and require extensive electro-optical conversions between hops. Additionally, each fiber requires manual trimming and installation (for example, in a crawl space) and electro-optical modules are required at each end. Further, large interconnect fabrics require complex electronic cross-bar switching between main and local fiber cables. Therefore, a need has arisen for a new way to couple between computing racks such as server racks in a data center.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

### DETAILED DESCRIPTION

Some embodiments of the inventions relate to rack to rack optical communication (for example, rack to rack free space optics).

In some embodiments a light transceiver is associated with a computing rack and is adapted to transmit and/or receive one or more light beams via air to and/or from a second light transceiver associated with a second computing rack to communicate information between the computing rack and the second computing rack.

According to some embodiments, free-space optical (FSO) interconnects are used to connect computing racks (for example, server racks and/or server racks in a data center). In some embodiments the computing racks are coupled using direct point-to-point links. In some embodiments the computing racks are coupled using mirrors (for example, using ceiling-mounted mirrors).

According to some embodiments, a free-space optical (FSO) link may be a laser pointer optical carrier with a high amount of modulated data (for example, hundreds of Gbs or gigabits per second). The narrow laser beam is directed over hundreds of meters with a high degree of collimation (for example, less than an inch of spread at the receiver). According to some embodiments, the laser beam can be reflected from mirrors (for example, mirrors on a ceiling), can intersect with other laser beams without any interference, and/or can be detected at the receiving end by angle-selective optics to remove multiple beam cross-talk.

According to some embodiments, a petascale computer rack supports a large number (for example, ten thousand) FSO transmitter/receivers (FSO transceivers). In some embodiments, these FSO transceivers are integrated on a wafer or chip-bonded board (for example, in a small pad at the top of the rack). According to some embodiments, the FSO transceivers create a high throughput fabric with hundreds of TB/s (terabytes per second) over a distance of, for example, one to one hundred meters. According to some embodiments, use of FSO transceivers to couple computing racks will eliminate the tangle, cost, and latency associated with optical fiber interconnects (for example, associated with optical fiber interconnects for exascale computing clusters). According to some embodiments, FSO transceivers are used to create a cable-free, plug-and-play data center.

According to some embodiments, free-space optics (FSO) is an optical communication technology that uses light propagating in free space to transmit data between two points. This technology is useful, for example, where physical connections by means of fiber optic cables, for example, are impractical due to high costs or other considerations.

According to some embodiments, free-space optical links may be implemented using infrared laser light, although low-data-rate communication is possible over short distances using light emitting diodes (LEDs). According to some embodiments, infrared data association (IrDA) is a simple version of FSO. In some embodiments IrDA defines physical specifications of communications protocol standards for short-range exchange of data over infrared light. Free-space optics have also previously been used for communications between spacecraft, although the stability and quality of such a link is highly dependent on atmospheric conditions such as rain, fog, dust and heat. Free-space optics can be used to connect local area networks (LANs), to cross a public road or other barriers that the sender and receiver do not own, to provide speedy service delivery of high-bandwidth access to optical fiber networks, etc.

Only about five percent of commercial buildings in the United States have fiber optic connections to their door, although most are within a mile or so of a fiber optic connection. This “last mile” is proving to be a major bottleneck to expanding broadband services to many potential customers. Therefore, free-space optics (FSO) have been viewed as a viable option to provide communication within this “last mile” to get a fast connection to the door of many buildings.

FSO systems are based on FSO transceivers that include, for example, one or more laser diode transmitters and a corresponding receiver (for example, in a housing that also includes optical lenses, data processors, fiber connections, and/or an alignment system). The FSO technology is protocol-independent, and can support many different types of networks. It can be used, for example, with ATM, SONET, Gigabit Ethernet, or virtually any other type of network or communication protocol.

FSO transceivers can be located almost anywhere (for example, on a rooftop, on a corner of a building, indoors behind a window, etc). Link distances between FSO transceivers have previously been used with variable distances (for example, in some outdoor applications up to a mile or more).

FSO networks have been used based on different wavelengths. For example, FSO networks have been used that are based on 780 nanometer (nm), 850 nm, or 1,550 nm laser wavelength systems, which have different power and distance characteristics. FSO has been operating in an unregulated section of the light spectrum, so no permits have been required by the Federal Communications Commission.

According to some embodiments, free-space optics (FSO) is an optical wireless technology that offers full-duplex Gigabit Ethernet throughput. This line-of-sight technology uses, for example, invisible beams of light to provide optical bandwidth connections. In some embodiments, FSO is capable of sending up to 1.25 gigabits per second of data, voice, and video communications simultaneously through the air, enabling fiber optic connectivity without requiring any physical fiber optic cable. Light travels faster through air than it does through glass, and FSO technology enables communications at the speed of light.

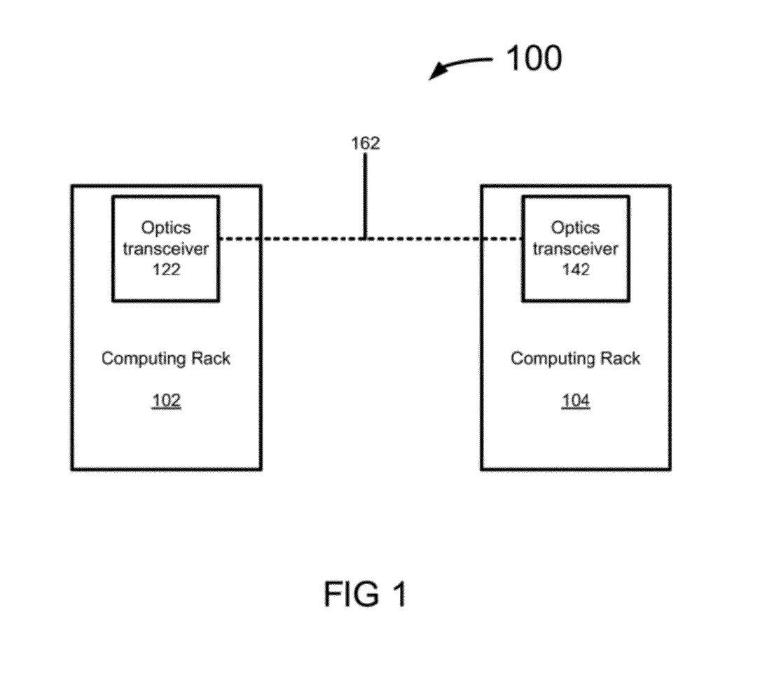

FIG. 1 illustrates a system 100 according to some embodiments. In some embodiments system 100 includes a computing rack 102 (for example, a server rack and/or a computing rack in a data center) and a computing rack 104 (for example, a server rack and/or a computing rack in the same data center). In some embodiments, a free-space optics (FSO) transceiver 122 is included in, on, near, around, and/or under computing rack 102, for example. In some embodiments, a free-space optics (FSO) transceiver 142 is included in, on, near, around, and/or under computing rack 104, for example. According to some embodiments, FSO transceiver 122 and FSO transceiver 142 provide a way to communicatively couple computing rack 102 and computing rack 104 via a light beam 162 (for example, an infrared light beam, a light emitting diode light beam, a laser beam, and/or an infrared laser beam).

In some embodiments, system 100 provides for a point-to-point light beam link between computing rack 102 and computing rack 104. Although system 100 is illustrated with only two computing racks 102 and 104, it is noted that in some embodiments, system 100 includes a larger number of computing racks and associated FSO transceivers, where each FSO transceiver facilitates a direct point-to-point link via a light beam between it's associated computing rack and one or more (or all) of the other FSO transceivers and their associated computing rack.

In some embodiments, each FSO transceiver includes a number of FSO transceivers (for example, a large number of FSO transceivers). In some embodiments, each of the FSO transceivers includes a large number of FSO transceivers that are each integrated on a wafer or chip-bonded board, for example. In some embodiments, the integrated FSO transceivers are integrated in a small pad in, on, or near an associated computing rack (for example, in some embodiments in a small pad at the top of the rack).

FIG. 1 illustrates a system 100 with FSO interconnects that couple computing racks (for example, computing racks in a data center and/or server racks) using direct point-to-point links. However, in some embodiments, FSO interconnects couple computing racks using indirect links (for example, via a mirror).

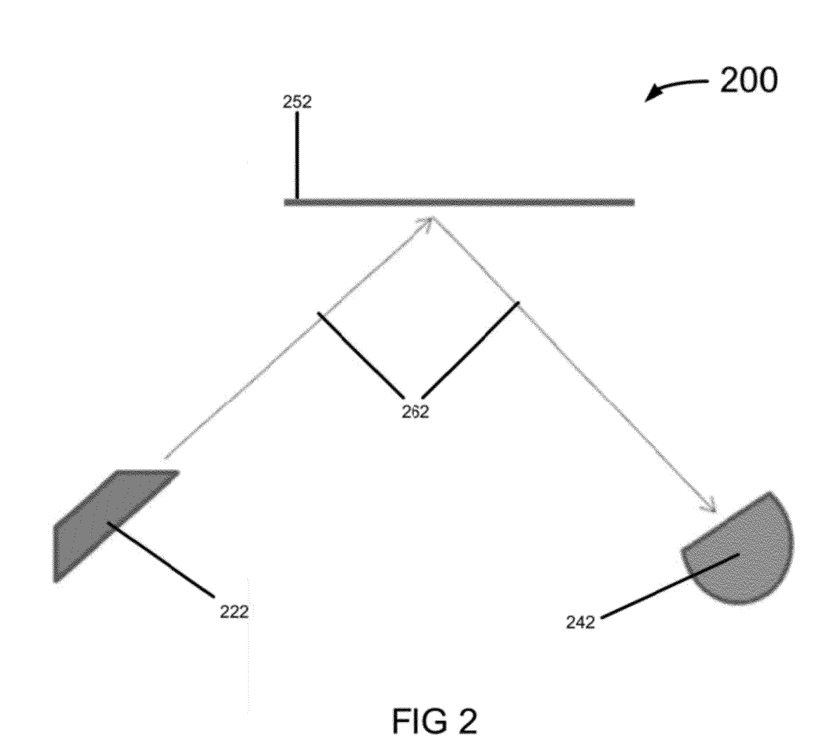

FIG. 2 illustrates a system 200 according to some embodiments. In some embodiments system 200 includes a light source 222 (for example, in some embodiments a laser), a receiver 242, and a mirror 252. In some embodiments, light source 222 is a free-space optics (FSO) transceiver associated with a first computing rack (for example, included in, on, near, around, and/or under the computing rack). In some embodiments, receiver 242 is a free-space optics (FSO) transceiver associated with a second computing rack (for example, included in, on, near, around, and/or under the second computing rack). According to some embodiments, light source 222, receiver 242, and mirror 252 provide a way to communicatively couple two computing racks via a light beam 262 (for example, an infrared light beam, a light emitting diode light beam, a laser beam, and/or an infrared laser beam). Light beam 262 is provided from light source 222, reflects off mirror 252 and is received by receiver 242. In some embodiments this provides an indirect link communicatively coupling two or more computing racks (for example, in some embodiments, two or more computing racks and/or server racks of a data center).

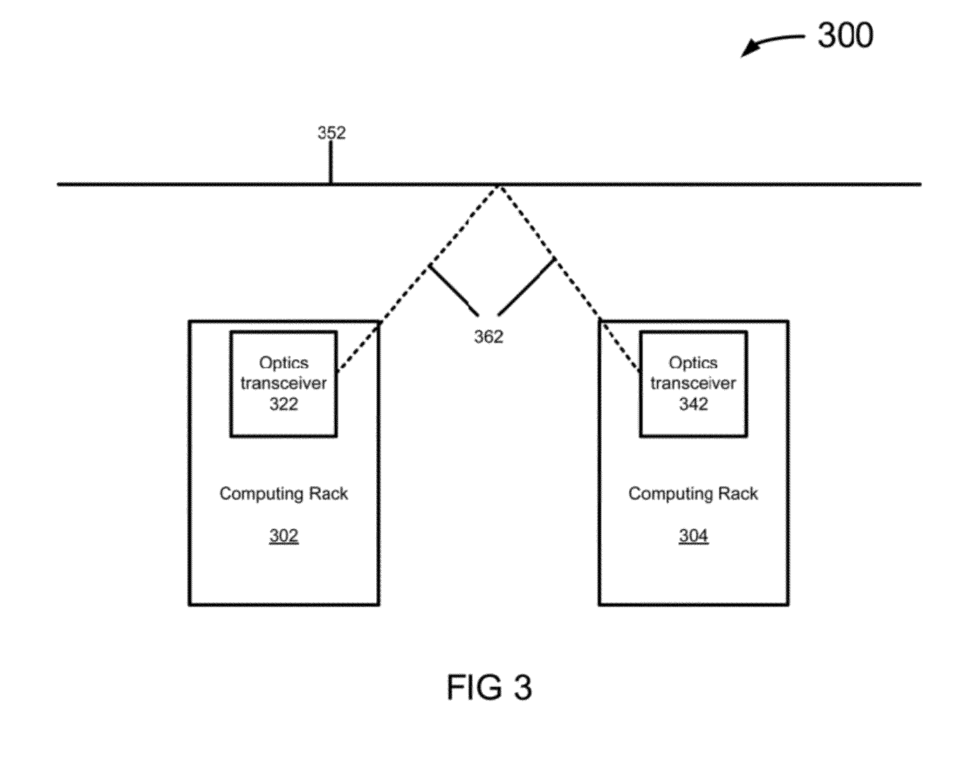

FIG. 3 illustrates a system 300 according to some embodiments. In some embodiments system 300 includes a computing rack 302 (for example, a server rack and/or a computing rack in a data center) and a computing rack 304 (for example, a server rack and/or a computing rack in the same data center). In some embodiments, a free-space optics (FSO) transceiver 322 is included in, on, near, around, and/or under computing rack 302, for example. In some embodiments, a free-space optics (FSO) transceiver 342 is included in, on, near, around, and/or under computing rack 304, for example. According to some embodiments, FSO transceiver 322 and FSO transceiver 342 provide a way to communicatively couple computing rack 302 and computing rack 304 via a mirror 352 that reflects a light beam 362 (for example, an infrared light beam, a light emitting diode light beam, a laser beam, and/or an infrared laser beam). In some embodiments, mirror 352 is a ceiling mounted mirror.

In some embodiments, system 300 provides for an indirect light beam link between computing rack 302 and computing rack 304. Although system 300 is illustrated with only two computing racks 302 and 304, it is noted that in some embodiments, system 300 includes a larger number of computing racks and associated FSO transceivers, where each FSO transceiver facilitates an indirect link via a light beam between it's associated computing rack and one or more (or all) of the other FSO transceivers and their associated computing rack. In some embodiments, some FSO transceivers couple their associated computing racks via a direct point-to-point light beam link and some FSO transceivers couple their associated computing racks via an indirect light beam link using mirror 352 and/or a plurality of mirrors.

In some embodiments, each FSO transceiver in FIG. 3 includes a number of FSO transceivers (for example, a large number of FSO transceivers). In some embodiments, each of the FSO transceivers includes a large number of FSO transceivers that are each integrated on a wafer or chip-bonded board, for example. In some embodiments, the integrated FSO transceivers are integrated in a small pad in, on, or near an associated computing rack (for example, in some embodiments in a small pad at the top of the rack).

According to some embodiments, free-space optical links remove any requirement for human involvement in reconfiguring computing racks (for example, in a data center). According to some embodiments, negative aspects associated with fiber optical cables are not a concern.

According to some embodiments, mirrors are in a manner that includes micro-mirror beam steering. According to some embodiments, active targets (mirrors or other computing racks) are acquired and/or tracked. In some embodiments, free-space beaming is used with on-chip photonic circuits (for example, for wavelength division multiplexing and modulation). According to some embodiments, use of FSO technology allows for I/O to scale as fast or faster than computation.

According to some embodiments, the laser beam can be reflected from mirrors (for example, mirrors on a ceiling), can intersect with other laser beams without any interference, and/or can be detected at the receiving end by angle-selective optics to remove multiple beam cross-talk.

According to some embodiments, high throughput interconnects are implemented at the one to one hundred meter level, allowing for at least a two times reduction in I/O cost, a six times reduction in I/O latency, and/or a ten thousand times increase in I/O bandwidth, overcoming limitations of traditional optical interconnects. Some embodiments provide for a huge cost savings in terms of the lack of need for large manpower required to install and maintain cabling in a data center. Some embodiments provide automated remote data center management. Additionally, some embodiments provide a high bandwidth and low latency, and will likely generate new programming models and system architecture models.

Some embodiments use free-space optic (FSO) light beam transmission using, for example, light beams, laser light, infrared light, infrared laser light, and/or Light Emitting Diodes (LEDs), etc.

Some embodiments include one or more of the following features:

1. Ten thousand transmitter/receivers (transceivers)

2. Ceiling mounted mirrors

3. 1-100 meter free space range

4. Integration of Semiconductor Optical Amplifiers (SOA) with Wave Division Multiplexing and 20 GBps modulators, mode coupling to low divergence beams. This allows optical IC's to handle large numbers of multiplexed optical signals and then amplify the resulting optical signal into a low divergence beam suitable for free space propagation and aiming.

5. Directional optics to remove spatial beam overlaps at receivers

6. Microelectromechanical Systems (MEMS) mirrors/lenses for directionality

7. Bar code mirrors for location and orientation

8. Compliance with DARPA Exascale I/O vision and/or requirements

9. Various discovery mechanisms

10. Rubber ceiling mirrors for focusing

11. Quantum optics for secure key distribution for fast rotation encryption schemes

12. Various broadcast modes (for example, fast system interrupts)

13. Spatial links for interconnect topology choices (for example, rack to near-rack to across room links)

14. Eye safety

15. Anti-vibration techniques

16. Adaptive control for atmospheric conditions (for example, heat plumes)

17. Optical path switching in the mirrors (for example, ceiling mirrors)

18. Mirrors (for example, ceiling mirrors) connected by light pipes

19. Mirrors (for example, ceiling mirrors) with SOAs for power boosting

20. Mirrors (for example, ceiling mirrors) with wireless power

21. Mirrors moved to below and/or sub-floor routing

22. Techniques to visualize beams for diagnostics and debugging

23. Beam security mechanisms to detect tapping

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a light transceiver associated with a computing rack and adapted to transmit and/or receive one or more light beams via air to and/or from a second light transceiver associated with a second computing rack to communicate information between the computing rack and the second computing rack.

2. The apparatus of claim 1, wherein the light transceiver is a free-space optics transceiver.

3. The apparatus of claim 1, wherein the one or more light beams are reflected via one or more mirrors between the light transceiver and the second light transceiver.

4. The apparatus of claim 1, wherein the computing rack is a server rack.

5. The apparatus of claim 1, wherein the computing rack and the second computing rack are located in a data center.

6. The apparatus of claim 1, wherein the one or more light beams are one or more laser light beams, infrared light beams, infrared laser light beams, and/or light emitting diode light beams.

7. The apparatus of claim 1, wherein the light transceiver is adapted to detect one or more light beams transmitted from the second transceiver using angle-selective optics to remove multiple beam cross-talk.

8. The apparatus of claim 1, the light transceiver adapted to transmit and/or receive one or more light beams via air to and/or from a third light transceiver associated with a third computing rack to communicate information between the computing rack and the third computing rack.

9. The apparatus of claim 1, wherein the light transceiver is coupled to, located in, on, near, around, attached to, and/or under the computing rack.

10. A system comprising:
a first computing rack;
a first light transceiver coupled to the computing rack and adapted to transmit and/or receive one or more light beams via air;
a second computing rack;
a second light transceiver associated with the second computing rack and adapted to transmit and/or receive the one or more light beams via air;
wherein the first light transceiver and the second light transceiver communicate information between the computing rack and the second computing rack via the one or more light beams.

11. The system of claim 10, wherein the first light transceiver and the second light receiver are free-space optics transceivers.

12. The system of claim 10, further comprising one or more mirrors, wherein the one or more light beams are reflected via the one or more mirrors between the first light transceiver and the second light transceiver.

13. The system of claim 12, wherein at least one of the one or more mirrors are ceiling mounted mirrors.

14. The system of claim 10, wherein the first computing rack is a server rack and the second computing rack is a server rack.

15. The system of claim 10, wherein the first computing rack and the second computing rack are located in a data center.

16. The system of claim 10, wherein the one or more light beams are one or more laser light beams, infrared light beams, infrared laser light beams, and/or light emitting diode light beams.

17. The system of claim 10, wherein the first light transceiver is adapted to detect one or more light beams transmitted from the second transceiver using angle-selective optics to remove multiple beam cross-talk.

18. The system of claim 10, further comprising:
a third computing rack; and
a third light transceiver associated with the third computing rack;
wherein the first light transceiver and/or the second light transceiver are adapted to transmit and/or receive one or more light beams via air to and/or from the third light transceiver to communicate information between the first computing rack, the second computing rack, and/or the third computing rack.

19. The system of claim 10, wherein the first light transceiver is coupled to, located in, on, near, around, attached to, and/or under the first computing rack.
